(19) United States
(12) Patent Application Publication
(10) Pub. No.: US 2017/0183267 A1
(43) Pub. Date: Jun. 29, 2017

(54) A METHOD OF MAKING A THERMALLY STABLE POLYCRYSTALLINE SUPER HARD CONSTRUCTION

(71) Applicant: Element Six (UK) Limited, Oxfordshire (GB)

(72) Inventors: Neil PERKINS, Oxfordshire (GB); Changzheng JI, Oxfordshire (GB); Nicola Louise PALMER, Oxfordshire (GB)

(21) Appl. No.: 15/313,601

(22) PCT Filed: May 29, 2015
(86) PCT No.: PCT/EP2015/062013

§ 371 Date: Nov. 23, 2016

(30) Foreign Application Priority Data
May 31, 2014 (GB) 1409701.8

(51) Int. Cl. C04B 35/528; C04B 35/626; C04B 35/645; E21B 10/567; C22C 26/00; B01J 3/06

(52) U.S. Cl. CPC C04B 35/528; C22C 26/00; B01J 3/062; C04B 35/645; E21B 10/567; C04B 35/62685; C04B 35/6261; B22F 2998/10; B01J 2203/0655; B01J 2203/0685; B01J 2203/062; C04B 2235/5472; C04B 2235/5436; C04B 2235/427; B22F 2005/001

(57) ABSTRACT

A method of making a thermally stable polycrystalline super hard construction having a plurality of interbonded super hard grains and interstitial regions disposed therebetween to form a polycrystalline super hard construction having a first thermally stable region and a second region, the first thermally stable region forming at least part of a working surface of the construction, comprises treating the polycrystalline super hard material with a leaching mixture to remove non-super hard phase material from a number of interstitial regions in the first region. The step of treating comprises masking the polycrystalline super hard construction along at least a portion of the peripheral side surface up to and/or at the working surface to inhibit penetration of the leaching mixture into the super hard construction through a peripheral side surface of the super hard construction. The material preferably is PCD, polycrystalline diamond, and preferably leaching takes place after forming a chamfer.

### FIELD

This disclosure relates to a method of making a thermally stable polycrystalline super hard construction comprising a body of polycrystalline super hard material such as polycrystalline diamond material (PCD).

### BACKGROUND

Cutter inserts for machining and other tools may comprise a layer of polycrystalline diamond (PCD) bonded to a cemented carbide substrate. PCD is an example of a super hard material, also called super abrasive material.

Components comprising PCD are used in a wide variety of tools for cutting, machining, drilling or degrading hard or abrasive materials such as rock, metal, ceramics, composites and wood-containing materials. PCD comprises a mass of substantially inter-grown diamond grains forming a skeletal mass which defines interstices between the diamond grains. PCD material typically comprises at least about 80 volume % of diamond and may be made by subjecting an aggregated mass of diamond grains to an ultra-high pressure of greater than about 5 GPa, for example about 5.5 GPa, and temperature of at least about 1200° C., typically about 1440° C., in the presence of a sintering aid, also referred to as a catalyst material for diamond. Catalyst materials for diamond are understood to be materials that are capable of promoting direct inter-growth of diamond grains at a pressure and temperature condition at which diamond is thermodynamically more stable than graphite.

Catalyst materials for diamond often include a Group VIII element and common examples are cobalt, iron, nickel and certain alloys including alloys of any of these elements. PCD may be formed on a cobalt-cemented tungsten carbide substrate, which may provide a source of cobalt catalyst material for the PCD. During sintering of the body of PCD material, a constituent of the cemented-carbide substrate, such as cobalt in the case of a cobalt-cemented tungsten carbide substrate, liquefies and sweeps from a region adjacent the volume of diamond particles into interstitial regions between the diamond particles. The cobalt acts as a catalyst to facilitate the formation of bonded diamond grains. Optionally, a metal-solvent catalyst may be mixed with diamond particles prior to subjecting the diamond particles and substrate to the HPHT process. The interstices within PCD material may at least partly be filled with the catalyst material. The intergrown diamond structure therefore comprises original diamond grains as well as a newly precipitated or re-grown diamond phase, which bridges the original grains. In the final sintered structure, residual catalyst/solvent material generally remains present within at least some of the interstices that exist between the sintered diamond grains.

A problem known to exist with such conventional PCD compacts is that they are vulnerable to thermal degradation when exposed to elevated temperatures during cutting and/or wear applications. It is believed that this is due, at least in part, to the presence of residual solvent/catalyst material in the microstructural interstices which, due to the differential that exists between the thermal expansion characteristics of the interstitial solvent metal catalyst material and the thermal expansion characteristics of the intercrystalline bonded diamond, is thought to have a detrimental effect on the performance of the PCD compact at high temperatures. Such differential thermal expansion is known to occur at temperatures of about 400 [deg.] C., and is believed to cause ruptures in the diamond-to-diamond bonding which may eventually result in the formation of cracks and chips in the PCD structure. The chipping of or cracking in the PCD table may degrade the mechanical properties of the cutting element comprising the PCD table or lead to failure of the cutting element during drilling or cutting operations thereby rendering the PCD structure unsuitable for further use.

Another form of thermal degradation known to exist with conventional PCD materials is also believed to be related to the presence of the residual solvent metal catalyst in the interstitial regions and the adherence of the solvent metal catalyst to the diamond crystals. Specifically, at high temperatures, diamond grains may undergo a chemical breakdown or back-conversion with the solvent/catalyst. At extremely high temperatures, the solvent metal catalyst is believed to cause an undesired catalyzed phase transformation in diamond such that portions of diamond grains may transform to carbon monoxide, carbon dioxide, graphite, or combinations thereof, thereby degrading the mechanical properties of the PCD material and limiting practical use of the PCD material to about 750 [deg.] C.

Attempts at addressing such unwanted forms of thermal degradation in conventional PCD materials are known in the art. Generally, these attempts have focused on the formation of a PCD body having an improved degree of thermal stability when compared to the conventional PCD materials discussed above. One known technique of producing a PCD body having improved thermal stability involves, after forming the PCD body, removing all or a portion of the solvent catalyst material therefrom using, for example, chemical leaching. Removal of the catalyst/binder from the diamond lattice structure renders the polycrystalline diamond layer more heat resistant.

Due to the hostile environment in which such cutting elements typically operate, cutting elements having cutting layers with improved abrasion resistance, strength and fracture toughness are desired. However, as PCD material is made more wear resistant, for example by removal of the residual catalyst material from interstices in the diamond matrix, it typically becomes more brittle and prone to fracture and therefore tends to have compromised or reduced resistance to spalling.

It has been appreciated by the applicant that cracks have a tendency to propagate in PCD cutting elements along the interface between the region(s) in the PCD from which non-diamond phase material such as residual catalyst/binder material has been substantially removed and the region(s) in the PCD in which non-diamond phase material remains at least in part in interstitial spaces between the interbonded diamond grains, that is, the interface between the leached and unleached regions of the PCD. It has been appreciated by the applicant that there is therefore a need to be able to control the creation of the desired profile of this interface boundary to control crack initiation and propagation in the PCD material, including the location and contour in the PCD table of the interface boundary between leached and unleached regions, to enable the provision of a PCD material having increased resistance to spalling and chipping.

### SUMMARY

Viewed from a first aspect there is provided a method of making a thermally stable polycrystalline super hard construction comprising a plurality of interbonded super hard grains and interstitial regions disposed therebetween to form a polycrystalline super hard construction having a first thermally stable region and a second region, the first thermally stable region forming at least part of a working surface of the construction, the method comprising:
treating the polycrystalline super hard material with a leaching mixture to remove non-super hard phase material from a number of interstitial regions in the first region;
the step of treating comprising masking the polycrystalline super hard construction along at least a portion of the peripheral side surface up to and/or at the working surface to inhibit penetration of the leaching mixture into the super hard construction through a peripheral side surface of the super hard construction.

In some examples, the step of removing non-super hard phase material from the interstitial regions in the first region comprises removing the non-super hard phase material to a depth in the first region that tapers towards the working surface at the intersection of the first region with the peripheral side surface of the polycrystalline super hard construction such that the depth of the first region at the peripheral side surface is less than the depth of the majority of the first region.

In some examples, the method further comprises machining the polycrystalline super hard construction to form a chamfer extending between a working surface positioned along an outside portion of the body and a peripheral side surface of the body after the step of treating the super hard construction with the leaching mixture.

The polycrystalline super hard construction may be formed, for example, of polycrystalline diamond material.

In some examples, the step of treating to remove non-super hard phase material comprises removing solvent/catalyst from the interstitial regions in the first region.

The step of treating further may comprise, for example in some examples, masking the super hard body across a portion of the working surface adjacent the intersection of the working surface with the peripheral side surface in addition to masking the super hard body along at least a portion of the peripheral side surface up to the working surface to inhibit penetration of the leaching mixture into the super hard construction through a peripheral side surface of the super hard construction and a portion of the working surface.

The step of masking the polycrystalline super hard construction may comprises any one or more of coating the super hard construction with a protective layer or mask, or placing a sealing member on and/or around the polycrystalline super hard construction, for example.

In some examples, prior to the step of treating, the method further comprises machining the polycrystalline super hard body to a final dimension, whilst in other examples this may occur after the step of treating the polycrystalline super hard construction.

### BRIEF DESCRIPTION OF THE DRAWINGS

Various versions will now be described in more detail, by way of example only, and with reference to the accompanying figures in which:

FIG. 1 is a schematic drawing of a PCD compact comprising a PCD structure bonded to a substrate;

FIG. 2 is a schematic drawing of the microstructure of a body of PCD material;

FIG. 3 is a schematic cross-section through a portion of the PCD compact of FIG. 1 according to an example;

FIG. 4 is a schematic cross-sectional view of the PCD cutter of FIG. 3 being held in a support structure during a treatment process according to an example; and

FIG. 5 is a plot of wear scar area against cutting length in a vertical borer test for an example.

### DETAILED DESCRIPTION

FIGS. 1 to 3 show an example of a polycrystalline composite construction 10 for use as a cutter insert for a drill bit (not shown) for boring into the earth. The polycrystalline composite compact or construction 10 comprises a body of polycrystalline super hard material 20 integrally bonded at an interface 24 to a substrate 30. The super hard material may be, for example, polycrystalline diamond (PCD) and the super hard particles or grains may be of natural or synthetic origin.

The substrate 30 may be formed of a hard material such as a cemented carbide material and may be, for example, cemented tungsten carbide, cemented tantalum carbide, cemented titanium carbide, cemented molybdenum carbide or mixtures thereof. The binder metal for such carbides suitable for forming the substrate 30 may be, for example, nickel, cobalt, iron or an alloy containing one or more of these metals. Typically, this binder will be present in an amount of 10 to 20 mass %, but this may be as low as 6 mass % or less. Some of the binder metal may infiltrate the body of polycrystalline super hard material 20 during formation of the compact 10.

As shown in FIG. 2, during formation of the polycrystalline composite construction 10, the interstices 14 between the grains 12 of super hard material such as diamond grains in the case of PCD, may be at least partly filled with a non-super hard phase material. This non-super hard phase material, also known as a filler material may comprise residual catalyst/binder material, for example cobalt, nickel or iron and may also, or in place of, include one or more other non-super hard phase additions such as, for example, Titanium, Tungsten, Niobium, Tantalum, Zirconium, Molybdenum, Chromium, or Vanadium. In some examples, the content of one or more of these additional elements within the filler material may be, for example, about 1 weight % of the filler material in the case of Ti, about 2 weight % of the filler material in the case of V, and, in the case of W, the content of W within the filler material may be, for example, about 20 weight % of the filler material.

PCT application publication number WO2008/096314 discloses a method of coating diamond particles, to enable the formation of polycrystalline super hard abrasive elements or composites, including polycrystalline super hard abrasive elements comprising diamond in a matrix of material(s) comprising one or more of VN, VC, HfC, NbC, TaC, Mo₂C, WC. PCT application publication number WO2011/141898 also discloses PCD and methods of forming PCD containing additions such as vanadium carbide to improve, inter alia, wear resistance.

Whilst wishing not to be bound by any particular theory, the combination of metal additives within the filler material may be considered to have the effect of better dispersing the energy of cracks arising and propagating within the PCD material in use, resulting in altered wear behaviour of the PCD material and enhanced resistance to impact and fracture, and consequently extended working life in some applications.

In accordance with some examples, a sintered body of PCD material is created having diamond to diamond bonding and having a second phase comprising catalyst/solvent and WC (tungsten carbide) dispersed through its microstructure together with or instead of a further non-diamond phase carbide such as VC. The body of PCD material may be formed according to standard methods, for example as described in PCT application publication number WO2011/141898, using HpHT conditions to produce a sintered PCD table.

The polycrystalline composite construction 10 when used as a cutting element may be mounted in use in a bit body, such as a drag bit body (not shown).

The substrate 30 may be, for example, generally cylindrical having a peripheral surface, a peripheral top edge and a distal free end.

The exposed surface of the super hard material 20 opposite the substrate 30 forms or comprises a working surface 34 which also acts as a rake face in use. A chamfer 44 typically extends between the working surface 34 and a cutting edge 36, and at least a part of a flank or barrel 42 of the cutter, the cutting edge 36 being defined by the edge of the chamfer 44 and the flank 42.

The working surface or “rake face” 34 of the polycrystalline composite construction 10 is the surface or surfaces over which the chips of material being cut flow when the cutter is used to cut material from a body, the rake face 34 directing the flow of newly formed chips. This face 34 is commonly also referred to as the top face or working surface of the cutting element as the working surface 34 is the surface which, along with its edge 36, is intended to perform the cutting of a body in use. It is understood that the term “cutting edge”, as used herein, refers to the actual cutting edge, defined functionally as above, at any particular stage or at more than one stage of the cutter wear progression up to failure of the cutter, including but not limited to the cutter in a substantially unworn or unused state.

As used herein, “chips” are the pieces of a body removed from the work surface of the body being cut by the polycrystalline composite construction 10 in use.

As used herein, the “flank” 42 of the cutter is the surface or surfaces of the cutter that passes over the surface produced on the body of material being cut by the cutter and is commonly referred to as the side or barrel of the cutter. The flank 42 may provide a clearance from the body and may comprise more than one flank face.

As used herein, a “wear scar” is a surface of a cutter formed in use by the removal of a volume of cutter material due to wear of the cutter. A flank face may comprise a wear scar. As a cutter wears in use, material may progressively be removed from proximate the cutting edge, thereby continually redefining the position and shape of the cutting edge, rake face and flank as the wear scar forms.

With reference to FIG. 3, the chamfer 44 is formed in the structure adjacent the cutting edge 36 and flank or barrel surface 42. Conventionally, the chamfer 44 is formed in the structure prior to the treatment of the PCD body to remove residual catalyst/binder material in the PCD structure. However, the present applicant has appreciated that it may be advantageous to form the chamfer 44 in the PCD structure after the treatment of the PCD body 20 to remove residual catalyst/binder phase. This is explained in more detail below.

The rake face 34 is joined to the flank 42 by the chamfer 44 which extends from the cutting edge 36 to the rake face 34, and lies in a plane at a predetermined angle θ to the plane perpendicular to the plane in which the longitudinal axis of the cutter extends. In some examples, this chamfer angle is up to around 45 degrees. The vertical height of the chamfer 44 may be, for example, between 350 μm and 450 μm, such as around 400 μm.

FIG. 3 is a schematic representation of the PCD construction 10 which has been treated to remove residual solvent/catalyst from interstitial spaces between the diamond grains using the techniques described in detail below. In this example, the depth Y of the PCD layer 20 from the working surface 34 towards the interface 24 with the substrate 30 from which the solvent/catalyst has been substantially removed is known as the leach depth. According to some examples, this depth Y tapers towards the working surface 34 at the intersection with the barrel 42 such that the leach depth at the longitudinal axis of the cutter is greater than the leach depth Y′ at the barrel surface 42. In some examples, the boundary between the leached region and unleached region intersects the barrel 42 of the cutter below the edge of the chamfer 44 that forms the cutting edge 36 in the new/unused condition.

Whilst not wishing to be bound by theory, it has been appreciated by the applicant that cracks have a tendency to propagate in the PCD along the interface between leached and unleached regions of the PCD and therefore it is desirable to be able to control the location and profile of this interface between the leached and unleached regions in the PCD. In particular, depending on the end application of the product, it may be advantageous to have an example such as that shown in FIG. 3 in which this boundary tapers towards the working surface 34 such that the leach depth at the longitudinal axis of the cutter is greater than the leach depth at the barrel surface 42 as this may assist in managing the thermal wear events of the construction 10 in use and assist in managing the spalling by diverting cracks initiating at the leached/unleached boundary where this boundary intersects the barrel 42 of the PCD body 20 into the centre of the cutter thereby potentially delaying the onset of spalling and prolonging the working life of the construction. This is in contrast to conventional cutters where the leaching profile tends to be tapered away from the working surface and towards the distal free end of the substrate. Furthermore, in other examples, it may be desirable to achieve a substantially flat interface between the leached and unleached regions in the PCD which may be difficult to achieve with conventional leaching techniques.

Control of the location and profile or contour of the boundary interface 50, for example whether the boundary interface 50 is substantially planar through the PCD body 20 or tapers toward the working surface 34 at the intersection of the boundary interface 50 with the barrel 42 and the degree of tapering of the boundary interface 50 in the region of the barrel 42, is desirable as it may enable control of the crack initiation sites and crack propagation in the PCD body during use and may thereby be tailored to suit the intended application of the PCD construction 10.

In some examples, the leach depth at the barrel surface 42 is at least around 100 microns below the cutting edge 36, whilst in other examples it may be between around 50 to 100 microns below the cutting edge 36, and in some examples it is less than around 50 microns and in others it intersects the chamfer surface 44 itself, depending on the intended application of the polycrystalline composite construction 10.

As used herein, the thickness of the body of PCD material 20 or the substrate 30 or some part of the body of PCD material or the substrate is the thickness measured substantially perpendicularly to the working surface 34. In some examples, the PCD structure, or body of PCD material 20 may have a generally wafer, disc or disc-like shape, or be in the general form of a layer. In some examples, the body of PCD material 20 may have a thickness of at least about 2.5 to at least 4.5 mm. In one example, the body of PCD material 20 may have a thickness in the range from about 2 mm to about 3.5 mm.

In some examples, the substrate 30 may have the general shape of a wafer, disc or post, and may be generally cylindrical in shape. The substrate 30 may have, for example, an axial thickness at least equal to or greater than the axial thickness of the body of PCD material 20 and may be for example at least about 1 mm, at least about 2.5 mm, at least about 3 mm, at least about 5 mm or even at least about 10 mm or more in thickness. In one example, the substrate 30 may have a thickness of at least 2 cm.

In some examples, the largest dimension of the body of PCD material 20 is around 6 mm or greater, for example in examples where the body of PCD material is cylindrical in shape, the diameter of the body is around 6 mm or greater and may be, for example, be up to around 19 mm or greater.

As shown in FIG. 2, the bodies of polycrystalline super hard material produced by an example additionally have a non-super hard phase 14 such as a binder phase present at least partly filling a number of the interstitial spaces between the inter-bonded particles or grains of super hard material 12. This non-super hard phase 14 may comprise a catalyst/solvent for the super hard abrasive particles 12. Catalyst/solvents for diamond are well known in the art. In the case of diamond, the binder may be, for example, cobalt, nickel, iron or an alloy containing one or more of these metals. This binder/catalyst/solvent may be introduced by infiltration into the mass of abrasive particles during the sintering treatment, or in particulate form as a mixture within the mass of abrasive particles. Infiltration may occur, for example, from a supplied shim or layer of the binder metal or from the carbide support. In some examples a combination of the admixing and infiltration approaches is used.

High pressure, high temperature treatment may be used to form the polycrystalline super hard material, during which the catalyst/solvent material melts and migrates through the compact layer, acting as a catalyst/solvent and causing the super hard particles to bond to one another. Once manufactured, the PCD construction therefore comprises a coherent matrix of super hard (eg diamond) particles bonded to one another, thereby forming a super hard polycrystalline composite material with many interstices or pools containing binder material as described above. In essence, the final super hard construction therefore comprises a two-phase composite, where the super hard abrasive material comprises one phase such as a diamond phase in the case of PCD and the binder phase (non-diamond phase), the other.

In one form, the super hard phase, for example diamond, constitutes between 80% and 95% by volume and the non-super hard phase (binder phase) formed, for example, of binder material the other 5% to 20%.

The relative distribution of the binder phase, and the number of voids or pools filled with this phase, is largely defined by the size and shape of the super hard grains.

In the case of PCD, the binder (non-diamond) phase may help to improve the impact resistance of the more brittle abrasive phase, but as the binder phase typically represents a far weaker and less abrasion resistant fraction of the structure, and high quantities will tend to adversely affect wear resistance. Additionally, where the binder phase is also an active solvent/catalyst material, its increased presence in the structure can compromise the thermal stability of the compact.

Examples of super hard constructions such as those shown in FIG. 3 may be made as follows. A green body comprising grains of super hard material and a binder, such as an organic binder is prepared. As used herein, a “green body” is a body comprising grains to be sintered and a means of holding the grains together, such as a binder, for example an organic binder.

The green body may also comprise catalyst material for promoting the sintering of the super hard grains. The green body may be made by combining the grains with the binder and forming them into a body having substantially the same general shape as that of the intended sintered body. At least some of the binder material may be dried and/or removed by, for example, burning it off.

The green body may be formed by a method such as a compaction process, or an injection process or other known methods such as molding, extrusion, or deposition modeling methods. In some examples, the components forming the green body may comprise the super hard grains and binder in the form of sheets, blocks or discs, for example, and the green body may itself be formed from green bodies.

One example of a method for making a green body may comprise providing tape cast sheets, each sheet comprising, for example, a plurality of diamond grains bonded together by a binder, such as a water-based organic binder, and stacking the sheets on top of one another and on top of a support body which is to form the substrate 30. Different sheets comprising diamond grains having different size distributions, diamond content or additives may be selectively stacked to achieve a desired structure. The sheets may be made by a method known in the art, such as extrusion or tape casting methods, wherein slurry comprising diamond grains and a binder material is laid onto a surface and allowed to dry. Other methods for making diamond-bearing sheets may also be used, such as described in U.S. Pat. Nos. 5,766,394 and 6,446,740. Alternative methods for depositing diamond-bearing layers include spraying methods, such as thermal spraying.

A green body for the super hard construction may be placed onto a substrate, such as a cemented carbide substrate to form a pre-sinter assembly, which may be encapsulated in a capsule for an ultra-high pressure furnace, as is known in the art. The substrate may provide a source of catalyst material for promoting the sintering of the super hard grains. In some examples, the super hard grains may be diamond grains and the substrate may be cobalt-cemented tungsten carbide, the cobalt in the substrate being a source of catalyst for sintering the diamond grains. The pre-sinter assembly may comprise an additional source of catalyst material.

In some versions of the method, prior to sintering, the aggregated mass of diamond particles/grains may be disposed against the surface of the substrate generally in the form of a layer having a thickness of least about 0.6 mm, at least about 1 mm, at least about 1.5 mm or even at least about 2 mm. The thickness of the mass of diamond grains may reduce significantly when the grains are sintered at an ultra-high pressure.

The mixture of super hard particles may be multimodal, that it is may comprise a mixture of fractions of diamond particles or grains that differ from one another discernibly in their average particle size. Typically the number of fractions may be:
a specific case of two fractions
three or more fractions.

By “average particle/grain size” it is meant that the individual particles/grains have a range of sizes with the mean particle/grain size representing the “average”. Hence the major amount of the particles/grains will be close to the average size, although there will be a limited number of particles/grains above and below the specified size. The peak in the distribution of the particles will therefore be at the specified size. The size distribution for each super hard particle/grain size fraction is typically itself monomodal, but may in certain circumstances be multimodal. In the sintered compact, the term “average particle grain size” is to be interpreted in a similar manner.

In one version, the method may include providing a cemented carbide substrate, contacting an aggregated, substantially unbonded mass of diamond particles against a surface of the substrate to form an pre-sinter assembly, encapsulating the pre-sinter assembly in a capsule for an ultra-high pressure furnace and subjecting the pre-sinter assembly to an ultra-high pressure and a temperature at which the super hard material is thermodynamically stable to sinter the super hard grains, for example, a pressure of at least about 5.5 GPa and a temperature of at least about 1,250 degrees centigrade. The sintered product may be formed of a PCD composite compact element comprising a PCD structure integrally formed on and joined to a cemented carbide substrate. In some examples of the invention, the pre-sinter assembly may be subjected to a pressure of at least about 6 GPa, at least about 6.5 GPa, at least about 7 GPa or even at least about 7.5 GPa.

A version of the method may include making a diamond composite structure by means of a method disclosed, for example, in PCT application publication number WO2009/128034 for making a super-hard enhanced hard-metal material. A powder blend comprising diamond particles, and a metal binder material, such as cobalt may be prepared by combining these particles and blending them together. An effective powder preparation technology may be used to blend the powders, such as wet or dry multi-directional mixing, planetary ball milling and high shear mixing with a homogenizer. In one example, the mean size of the diamond particles may be at least about 50 microns and they may be combined with other particles by mixing the powders or, in some cases, stirring the powders together by hand. In one version of the method, precursor materials suitable for subsequent conversion into binder material may be included in the powder blend, and in one version of the method, metal binder material may be introduced in a form suitable for infiltration into a green body. The powder blend may be deposited in a die or mold and compacted to form a green body, for example by uni-axial compaction or other compaction method, such as cold isostatic pressing (CIP). The green body may then be subjected to a sintering process known in the art and as described above to form the sintered article.

The sintered article may be subjected to a subsequent treatment at a pressure and temperature at which diamond is thermally stable to convert some or all of the non-diamond carbon back into diamond and produce a diamond composite structure. An ultra-high pressure furnace well known in the art of diamond synthesis may be used and the pressure may be at least about 5.5 GPa and the temperature may be at least about 1,250 degrees centigrade for the second sintering process.

A further example of a super hard construction may be made by a method including providing a PCD structure and a precursor structure for a diamond composite structure, forming each structure into the respective complementary shapes, assembling the PCD structure and the diamond composite structure onto a cemented carbide substrate to form an unjoined assembly, and subjecting the unjoined assembly to a pressure of at least about 5.5 GPa and a temperature of at least about 1,250 degrees centigrade to form a PCD construction. The precursor structure may comprise carbide particles and diamond or non-diamond carbon material, such as graphite, and a binder material comprising a metal, such as cobalt. The precursor structure may be a green body formed by compacting a powder blend comprising particles of diamond or non-diamond carbon and particles of carbide material and compacting the powder blend.

As mentioned above, the grains of super hard material, such as diamond grains or particles in the starting mixture prior to sintering may be multimodal, for example, bimodal, that is, the feed comprises a mixture of a coarse fraction of diamond grains and a fine fraction of diamond grains. In some examples, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction, for example between around 1/10 to 6/10 of the size of the coarse fraction, and may, in some examples, range for example between about 0.1 to 20 microns.

In some examples, the weight ratio of the coarse diamond fraction to the fine diamond fraction ranges from about 50% to about 97% coarse diamond and the weight ratio of the fine diamond fraction may be from about 3% to about 50%. In other examples, the weight ratio of the coarse fraction to the fine fraction will range from about 70:30 to about 90:10.

In further examples, the weight ratio of the coarse fraction to the fine fraction may range for example from about 60:40 to about 80:20.

In some examples, the particle size distributions of the coarse and fine fractions do not overlap and in some examples the different size components of the compact are separated by an order of magnitude between the separate size fractions making up the multimodal distribution.

The examples consists of at least a wide bi-modal size distribution between the coarse and fine fractions of super hard material, but some examples may include three or even four or more size modes which may, for example, be separated in size by an order of magnitude, for example, a blend of particle sizes whose average particle size is 20 microns, 2 microns, 200 nm and 20 nm.

Sizing of diamond particles/grains into fine fraction, coarse fraction, or other sizes in between, may be through known processes such as jet-milling of larger diamond grains and the like.

In examples where the super hard material is polycrystalline diamond material, the diamond grains used to form the polycrystalline diamond material may be natural or synthetic.

In some examples, the binder catalyst/solvent may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some examples, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some examples, the metal carbide is tungsten carbide.

In some examples, both the bodies of, for example, diamond and carbide material plus sintering aid/binder/catalyst are applied as powders and sintered simultaneously in a single UHP/HT process. The mixture of diamond grains and mass of carbide are placed in an HP/HT reaction cell assembly and subjected to HP/HT processing. The HP/HT processing conditions selected are sufficient to effect intercrystalline bonding between adjacent grains of abrasive particles and, optionally, the joining of sintered particles to the cemented metal carbide support. In one example, the processing conditions generally involve the imposition for about 3 to 120 minutes of a temperature of at least about 1200 degrees C. and an ultra-high pressure of greater than about 5 GPa.

In another example, the substrate may be pre-sintered in a separate process before being bonded together in the HP/HT press during sintering of the super hard polycrystalline material.

In a further example, both the substrate and a body of polycrystalline super hard material are pre-formed. For example, the bimodal feed of super hard grains/particles with optional carbonate binder-catalyst also in powdered form are mixed together, and the mixture is packed into an appropriately shaped canister and is then subjected to extremely high pressure and temperature in a press. Typically, the pressure is at least 5 GPa and the temperature is at least around 1200 degrees C. The preformed body of polycrystalline super hard material is then placed in the appropriate position on the upper surface of the preform carbide substrate (incorporating a binder catalyst), and the assembly is located in a suitably shaped canister. The assembly is then subjected to high temperature and pressure in a press, the order of temperature and pressure being again, at least around 1200 degrees C. and 5 GPa respectively. During this process the solvent/catalyst migrates from the substrate into the body of super hard material and acts as a binder-catalyst to effect intergrowth in the layer and also serves to bond the layer of polycrystalline super hard material to the substrate. The sintering process also serves to bond the body of super hard polycrystalline material to the substrate.

The practical use of cemented carbide grades with substantially lower cobalt content as substrates for PCD inserts is limited by the fact that some of the Co is required to migrate from the substrate into the PCD layer during the sintering process in order to catalyze the formation of the PCD. For this reason, it is more difficult to make PCD on substrate materials comprising lower Co contents, even though this may be desirable.

The hardness of cemented tungsten carbide substrate may be enhanced by subjecting the substrate to an ultra-high pressure and high temperature, particularly at a pressure and temperature at which diamond is thermodynamically stable. The magnitude of the enhancement of the hardness may depend on the pressure and temperature conditions. In particular, the hardness enhancement may increase the higher the pressure. Whilst not wishing to be bound by a particular theory, this is considered to be related to the Co drift from the substrate into the PCD during press sintering, as the extent of the hardness increase is directly dependent on the decrease of Co content in the substrate.

In examples where the cemented carbide substrate does not contain sufficient solvent/catalyst for diamond, and where the PCD structure is integrally formed onto the substrate during sintering at an ultra-high pressure, solvent/catalyst material may be included or introduced into the aggregated mass of diamond grains from a source of the material other than the cemented carbide substrate. The solvent/catalyst material may comprise cobalt that infiltrates from the substrate in to the aggregated mass of diamond grains just prior to and during the sintering step at an ultra-high pressure. However, in examples where the content of cobalt or other solvent/catalyst material in the substrate is low, particularly when it is less than about 11 weight percent of the cemented carbide material, then an alternative source may need to be provided in order to ensure good sintering of the aggregated mass to form PCD.

Solvent/catalyst for diamond may be introduced into the aggregated mass of diamond grains by various methods, including blending solvent/catalyst material in powder form with the diamond grains, depositing solvent/catalyst material onto surfaces of the diamond grains, or infiltrating solvent/catalyst material into the aggregated mass from a source of the material other than the substrate, either prior to the sintering step or as part of the sintering step. Methods of depositing solvent/catalyst for diamond, such as cobalt, onto surfaces of diamond grains are well known in the art, and include chemical vapour deposition (CVD), physical vapour deposition (PVD), sputter coating, electrochemical methods, electroless coating methods and atomic layer deposition (ALD). It will be appreciated that the advantages and disadvantages of each depend on the nature of the sintering aid material and coating structure to be deposited, and on characteristics of the grain.

In one example, cobalt may be deposited onto surfaces of the diamond grains by first depositing a pre-cursor material and then converting the precursor material to a material that comprises elemental metallic cobalt. For example, in the first step cobalt carbonate may be deposited on the diamond grain surfaces using the following reaction:

Co(NO₃)₂+Na₂CO₃→CoCO₃+2NaNO₃

The deposition of the carbonate or other precursor for cobalt or other solvent/catalyst for diamond may be achieved by means of a method described in PCT patent publication number WO/2006/032982. The cobalt carbonate may then be converted into cobalt and water, for example, by means of pyrolysis reactions such as the following:

CoCO₃→CoO+CO₂

CoO+H₂→Co+H₂O

In another example, cobalt powder or precursor to cobalt, such as cobalt carbonate, may be blended with the diamond grains. Where a precursor to a solvent/catalyst such as cobalt is used, it may be necessary to heat treat the material in order to effect a reaction to produce the solvent/catalyst material in elemental form before sintering the aggregated mass.

In some examples, the cemented carbide substrate may be formed of tungsten carbide particles bonded together by the binder material, the binder material comprising an alloy of Co, Ni and Cr. The tungsten carbide particles may form at least 70 weight percent and at most 95 weight percent of the substrate. The binder material may comprise between about 10 to 50 wt. % Ni, between about 0.1 to 10 wt. % Cr, and the remainder weight percent comprises Co. The size distribution of the tungsten carbide particles in the cemented carbide substrate ion some examples has the following characteristics:
fewer than 17 percent of the carbide particles have a grain size of equal to or less than about 0.3 microns;
between about 20 to 28 percent of the tungsten carbide particles have a grain size of between about 0.3 to 0.5 microns;
between about 42 to 56 percent of the tungsten carbide particles have a grain size of between about 0.5 to 1 microns;
less than about 12 percent of the tungsten carbide particles are greater than 1 micron; and
the mean grain size of the tungsten carbide particles is about 0.6±0.2 microns.

In some examples, the binder additionally comprises between about 2 to 20 wt. % tungsten and between about 0.1 to 2 wt. % carbon

A layer of the substrate adjacent to the interface with the body of polycrystalline diamond material may have a thickness of, for example, around 100 microns and may comprise tungsten carbide grains, and a binder phase. This layer may be characterized by the following elemental composition measured by means of Energy-Dispersive X-Ray Microanalysis (EDX):
between about 0.5 to 2.0 wt % cobalt;
between about 0.05 to 0.5 wt. % nickel;
between about 0.05 to 0.2 wt. % chromium; and
tungsten and carbon.

In a further example, in the layer described above in which the elemental composition includes between about 0.5 to 2.0 wt % cobalt, between about 0.05 to 0.5 wt. % nickel and between about 0.05 to 0.2 wt. % chromium, the remainder is tungsten and carbon.

The layer of substrate may further comprise free carbon.

The magnetic properties of the cemented carbide material may be related to important structural and compositional characteristics. The most common technique for measuring the carbon content in cemented carbides is indirectly, by measuring the concentration of tungsten dissolved in the binder to which it is indirectly proportional: the higher the content of carbon dissolved in the binder the lower the concentration of tungsten dissolved in the binder. The tungsten content within the binder may be determined from a measurement of the magnetic moment, σ, or magnetic saturation, Mₛ=4πσ, these values having an inverse relationship with the tungsten content (Roebuck (1996), “Magnetic moment (saturation) measurements on cemented carbide materials”, Int. J. Refractory Met., Vol. 14, pp. 419-424.). The following formula may be used to relate magnetic saturation, Ms, to the concentrations of W and C in the binder:

Mₛ∝[C]/[W]×wt. % Co×201.9 in units of μT·m³/kg

The binder cobalt content within a cemented carbide material may be measured by various methods well known in the art, including indirect methods such as such as the magnetic properties of the cemented carbide material or more directly by means of energy-dispersive X-ray spectroscopy (EDX), or a method based on chemical leaching of Co.

The mean grain size of carbide grains, such as WC grains, may be determined by examination of micrographs obtained using a scanning electron microscope (SEM) or light microscopy images of metallurgically prepared cross-sections of a cemented carbide material body, applying the mean linear intercept technique, for example. Alternatively, the mean size of the WC grains may be estimated indirectly by measuring the magnetic coercivity of the cemented carbide material, which indicates the mean free path of Co intermediate the grains, from which the WC grain size may be calculated using a simple formula well known in the art. This formula quantifies the inverse relationship between magnetic coercivity of a Co-cemented WC cemented carbide material and the Co mean free path, and consequently the mean WC grain size. Magnetic coercivity has an inverse relationship with MFP.

As used herein, the “mean free path” (MFP) of a composite material such as cemented carbide is a measure of the mean distance between the aggregate carbide grains cemented within the binder material. The mean free path characteristic of a cemented carbide material may be measured using a micrograph of a polished section of the material. For example, the micrograph may have a magnification of about 1000×. The MFP may be determined by measuring the distance between each intersection of a line and a grain boundary on a uniform grid. The matrix line segments, Lm, are summed and the grain line segments, Lg, are summed. The mean matrix segment length using both axes is the “mean free path”. Mixtures of multiple distributions of tungsten carbide particle sizes may result in a wide distribution of MFP values for the same matrix content. This is explained in more detail below.

The concentration of W in the Co binder depends on the C content. For example, the W concentration at low C contents is significantly higher. The W concentration and the C content within the Co binder of a Co-cemented WC (WC—Co) material may be determined from the value of the magnetic saturation. The magnetic saturation 4πσ or magnetic moment σ of a hard metal, of which cemented tungsten carbide is an example, is defined as the magnetic moment or magnetic saturation per unit weight. The magnetic moment, σ, of pure Co is 16.1 micro-Tesla times cubic metre per kilogram (μT·m³/kg), and the induction of saturation, also referred to as the magnetic saturation, 4πσ, of pure Co is 201.9 μT·m³/kg.

In some examples, the cemented carbide substrate may have a mean magnetic coercivity of at least about 100 Oe and at most about 145 Oe, and a magnetic moment of specific magnetic saturation with respect to that of pure Co of at least about 89 percent to at most about 97 percent.

A desired MFP characteristic in the substrate may be accomplished several ways known in the art. For example, a lower MFP value may be achieved by using a lower metal binder content. A practical lower limit of about 3 weight percent cobalt applies for cemented carbide and conventional liquid phase sintering. In an example where the cemented carbide substrate is subjected to an ultra-high pressure, for example a pressure greater than about 5 GPa and a high temperature (greater than about 1,400° C. for example), lower contents of metal binder, such as cobalt, may be achieved. For example, where the cobalt content is about 3 weight percent and the mean size of the WC grains is about 0.5 micron, the MFP would be about 0.1 micron, and where the mean size of the WC grains is about 2 microns, the MFP would be about 0.35 microns, and where the mean size of the WC grains is about 3 microns, the MFP would be about 0.7 microns. These mean grain sizes correspond to a single powder class obtained by natural comminution processes that generate a log normal distribution of particles. Higher matrix (binder) contents would result in higher MFP values.

Changing grain size by mixing different powder classes and altering the distributions may achieve a whole spectrum of MFP values for the substrate depending on the particulars of powder processing and mixing. The exact values would have to be determined empirically.

In some examples, the substrate comprises Co, Ni and Cr.

The binder material for the substrate may include at least about 0.1 weight percent to at most about 5 weight percent one or more of V, Ta, Ti, Mo, Zr, Nb and Hf in solid solution.

In further examples, the polycrystalline diamond (PCD) composite compact element may include at least about 0.01 weight percent and at most about 2 weight percent of one or more of Re, Ru, Rh, Pd, Re, Os, Ir and Pt.

Some examples of a cemented carbide body may be formed by providing tungsten carbide powder having a mean equivalent circle diameter (ECD) size in the range from about 0.2 microns to about 0.6 microns, the ECD size distribution having the further characteristic that fewer than 45 percent of the carbide particles have a mean size of less than 0.3 microns; 30 to 40 percent of the carbide particles have a mean size of at least 0.3 microns and at most 0.5 microns; 18 to 25 percent of the carbide particles have a mean size of greater than 0.5 microns and at most 1 micron; fewer than 3 percent of the carbide particles have a mean size of greater than 1 micron. The tungsten carbide powder is milled with binder material comprising Co, Ni and Cr or chromium carbides, the equivalent total carbon comprised in the blended powder being, for example, about 6 percent with respect to the tungsten carbide. The blended powder is then compacted to form a green body and the green body is sintered to produce the cemented carbide body.

The sintering the green body may take place at a temperature of, for example, at least 1,400 degrees centigrade and at most 1,440 degrees centigrade for a period of at least 65 minutes and at most 85 minutes.

In some examples, the equivalent total carbon (ETC) comprised in the cemented carbide material is about 6.12 percent with respect to the tungsten carbide.

The size distribution of the tungsten carbide powder may, in some examples, have the characteristic of a mean ECD of 0.4 microns and a standard deviation of 0.1 microns.

In some examples, the diamond content of the sintered diamond structure is greater than 90 vol % and the coarsest fraction of the distribution is greater than 60 weight %, and in some examples greater than weight 70%.

In polycrystalline diamond material, individual diamond particles/grains are, to a large extent, bonded to adjacent particles/grains through diamond bridges or necks. The individual diamond particles/grains retain their identity, or generally have different orientations. The average grain/particle size of these individual diamond grains/particles may be determined using image analysis techniques. Images are collected on a scanning electron microscope and are analyzed using standard image analysis techniques. From these images, it is possible to extract a representative diamond particle/grain size distribution.

Generally, the body of polycrystalline diamond material will be produced and bonded to the cemented carbide substrate in a HPHT process. In so doing, it is advantageous for the binder phase and diamond particles to be arranged such that the binder phase is distributed homogeneously and is of a fine scale.

The homogeneity or uniformity of the sintered structure is defined by conducting a statistical evaluation of a large number of collected images. The distribution of the binder phase, which is easily distinguishable from that of the diamond phase using electron microscopy, can then be measured in a method similar to that disclosed in EP 0974566. This method allows a statistical evaluation of the average thicknesses of the binder phase along several arbitrarily drawn lines through the microstructure. This binder thickness measurement is also referred to as the “mean free path” by those skilled in the art. For two materials of similar overall composition or binder content and average diamond grain size, the material which has the smaller average thickness will tend to be more homogenous, as this implies a “finer scale” distribution of the binder in the diamond phase. In addition, the smaller the standard deviation of this measurement, the more homogenous is the structure. A large standard deviation implies that the binder thickness varies widely over the microstructure, i.e. that the structure is not even, but contains widely dissimilar structure types.

Once sintered, the sintered PCD construction is then subjected to a post-synthesis treatment to assist in improving thermal stability of the sintered structure, by removing catalyzing material from a region of the polycrystalline layer adjacent an exposed surface thereof, namely the working surface opposite the substrate. It has been found that the removal of non-binder phase from within the PCD table, conventionally referred to as leaching, is desirable in various applications. The residual presence of solvent/catalyst material in the microstructural interstices is believed to have a detrimental effect on the performance of PCD compacts at high temperatures as it is believed that the presence of the solvent/catalyst in the diamond table reduces the thermal stability of the diamond table at these elevated temperatures. Therefore leaching is desired to enhance thermal stability of the PCD body. However, conventional leaching of solvent/catalyst material from a PCD structure is generally known to reduce its fracture toughness and strength by between 20 to 30%.

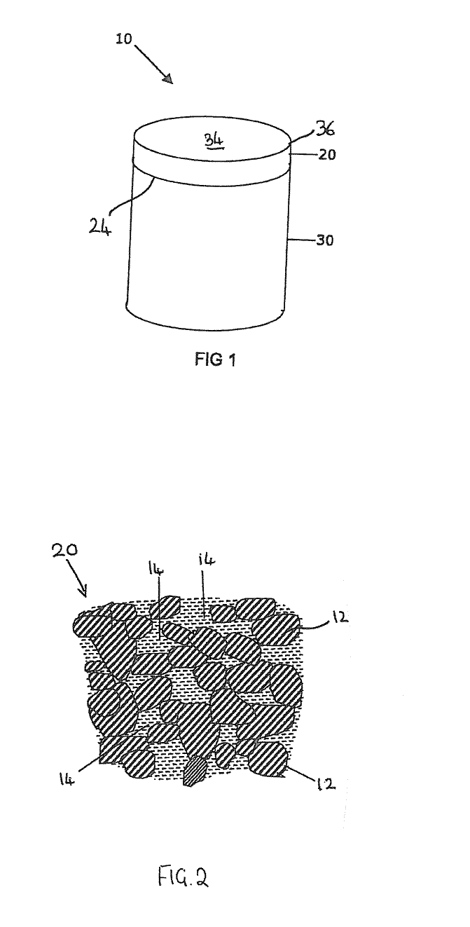

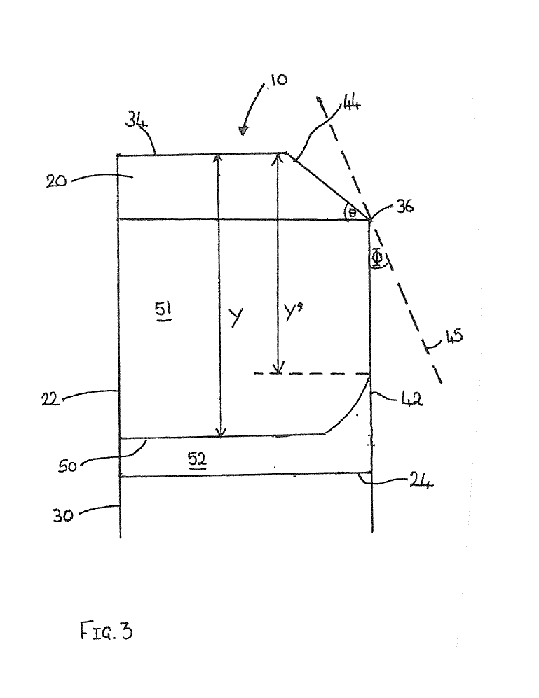

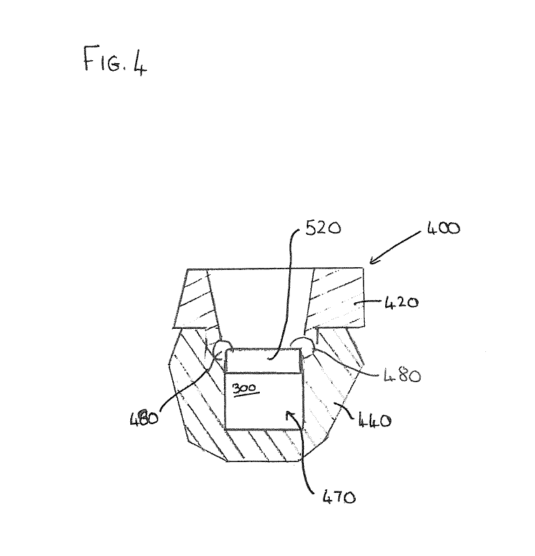

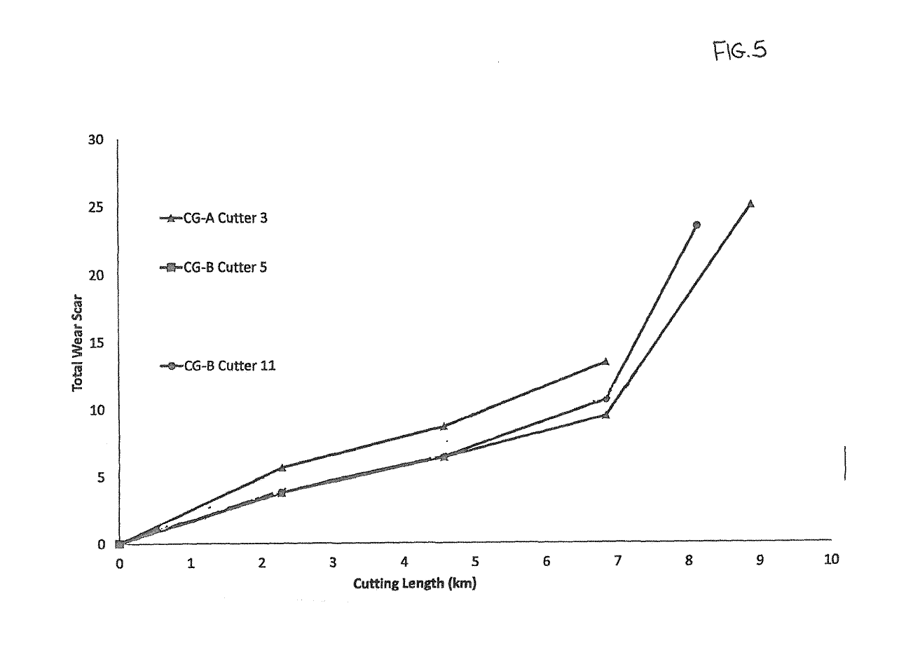

FIG. 4 shows the PCD cutter of FIG. 3 being held in a support structure during a treatment process used to control the profile or contour of the boundary interface 50 after sintering of the PCD cutter. Removal of the catalyzing material may be carried out using methods known in the art such as electrolytic etching, acid leaching or evaporation techniques. However, control of the desired leaching profiles of the examples may be obtained by, for example, the additional steps set out below.

In some examples, a protective layer, or mask is applied to the body of PCD material that extends up to the working surface 34 and over a portion of the working surface at the cutting edge, even though residual catalyst/solvent is to be removed from this portion of the working surface. In some examples, as shown in FIG. 4, a sealing member such as an O-ring 480 may be used to inhibit the leaching mixture from penetrating the barrel 42 of the cutter from the outer peripheral surface thereof and the working surface at the cutting edge, depending on the leaching technique to be applied and the fixtures holding the construction during the leaching process. The protective layer, mask or sealing member is designed to prevent the leaching solution from penetrating the barrel 42 of the cutter from the outer peripheral surface thereof during leaching and the positioning of the mask, barrier layer or sealing member at the working surface 36 has been determined to effect the leaching profile shown in FIG. 3 as it enables control of the location and profile of the interface boundary 50 between the leached and unleached portions of the body of PCD material. Following leaching, the protective layer or mask may be removed.

Various systems for protecting non-leached portions of a PCD element and providing a mask are known to include, for example, encasing the PCD element in a protective material and removing the masking material from the regions to be leached, or coating the portion of the element to not be leached with a masking material. However, conventional leaching techniques typically expose at least a portion of the outer surface of the barrel 42 of the PCD body 20 and the cutting edge and portion of the working surface adjacent thereto directly to the acid leaching mixture with the mask, coating or sealing element typically being located at a position on the barrel of the PCD body to separate the portion of the PCD to be leached from the portion of the PCD element which is not to be leached, thereby exposing the barrel of the portion of the PCD body to be leached directly to the leaching mixture. The present applicants have appreciated that, surprisingly, inhibiting the leaching mixture from penetrating the barrel 42 of the cutter from the outer peripheral surface thereof including at the cutting edge and area of the working surface adjacent thereto and controlling instead the exposure of the PCD body 20 to the acid leaching mixture through other exposed surfaces of the PCD body provides control over the location and contour of this interface boundary 50 between leached 51 and unleached regions 52. Additionally, it has been appreciated that control may be enhanced if the treatment of the PCD body to remove non-super hard phase material from the interstices in the PCD body is carried out on the PCD body prior to final finishing of the body such as to create the chamfer 44.

FIG. 4 shows a leaching system according to one example. The leaching system 400 includes a support 420 comprising a cup portion 440 having an upper rim 460 defining an aperture into which is located the PCD construction 470 to be leached. A sealing element 480 such as an elastomeric O-ring seal is located on a flange adjacent the rim of the cup portion 440 or may be locatable in a groove in the inner peripheral wall defining the aperture in the support and acts to extend around the PCD element 100 up to the working surface at the cutting edge and over a portion of the working surface at the cutting edge, the centre-point of the O-ring seal 480 being above the working surface of the PCD construction. The support 420 is shaped to leave exposed the region of the PCD element which is to be subjected to the leaching mixture during the treatment process. The cup 440 and sealing element 480 shown in FIG. 4 are therefore designed to encapsulate the desired surfaces of the substrate 300 and part of the PCD construction 470 which are not to be leached.

In some examples, the sealing element 480 may be formed from a polyketone based plastics materials such as PEEK or another protective elastomer material.

As shown in FIG. 4 the support 420 is configured as having a cylindrical cup portion 440 with an inside surface diameter that is sized to fit concentrically around the outside surface of the PCD construction 470 to be processed. The groove or flange in or on which is located the sealing element 480 extends circumferentially around an inner rim positioned adjacent to an end of the cup portion 440. In an alternative example (not shown), the support 420 may be configured without a groove and a suitable seal may simply be interposed between the opposed respective PCD construction 470 and support 420 outside and inside diameter surfaces, for example sitting on top of the working surface of the PCD construction such that when secured in the fixture the seal deforms to cover a portion of the working surface and the cutting edge as shown in FIG. 4. When placed around the outside surface of the PCD construction 470 at the cutting edge such that it also extends over/around the cutting edge, the seal 480 operates to provide a leak-tight seal between the PCD element 100 and the support 420 to prevent unwanted direct contact with the leaching agent.

In preparation for treatment, the support 420 is positioned axially over the PCD construction 470 and the PCD construction 470 is located into the support 420 with the working surface of the PCD construction 470 being exposed but the barrel of the PCD body being in sealed engagement with the inside wall of the cup portion 440. Positioned in this manner within the support 420, the working surface of the PCD construction 470 is freely exposed to make contact with the leaching agent but the leaching agent is inhibited from penetrating the PCD body from the outer peripheral surface of the PCD body and at the cutting edge. As mentioned above in the context of masking using a protective coating, to achieve the desired leaching profile shown in FIG. 3, the seal 480 is positioned adjacent the working surface 360 of the PCD construction 470 and, in some examples, the mask, barrier layer or sealing member 480 may extend partially across the working surface of the PCD layer. It has surprisingly been appreciated by the applicant such masking may enable further control over the profile and contour of the interface boundary 50 to reduce the distance Y′ shown in FIG. 3 which enables control over where the boundary interface 50 intersects the barrel 42 of the PCD body and the shape of the interface in the region where cracks formed in use have a tendency to initiate and propagate.

The PCD construction 470 and support fixture 420 form an assembly 400 that are then placed into a suitable container (not shown) that includes a desired volume of the leaching agent. In some examples, the leaching vessel may be a pressure vessel.

In some examples, the PCD construction 470 and support fixture 420 may be first placed in a leaching vessel and then the leaching agent may be added, or the leaching agent may be added to the leaching vessel before the PCD construction 470 is placed in the leaching vessel. This step may be performed by hand or using an automated system, such as a robotic system.

The leaching agent may be any chemical leaching agent. In particular examples, it may be a leaching agent as described herein.

The leaching process may be aided by stirring the leaching agent or otherwise agitating it, for example by ultrasonic methods, vibrations, or tumbling.

Leaching may take place over a time span of a few hours to a few months. In particular examples, it may take less than one day (24 hours), less than 50 hours, or less than one week. Leaching may be performed at room temperature or at a lower temperature, or at an elevated temperature, such as the boiling temperature of the leaching mixture. Exposing the body of PCD material 20 to an elevated temperature during leaching may increase the depth to which the PCD material 20 may be leached and reduce the leaching time necessary to reach the desired leach depth. In some examples, the leaching process may also be conducted at an elevated pressure.

Additionally, in some examples, at least a portion of the body of PCD material 20 and the leaching solution may be exposed to at least one of an electric current, microwave radiation, and/or ultrasonic energy to increase the rate at which the body of PCD material 20 is leached.

The duration and conditions of the leaching treatment process may be determined by a variety of factors including, but not limited to, the leaching agent used, the depth to which the PCD construction 470 is to be leached, and the percentage of catalyst to be removed from the leached portion of the PCD construction 470.

In some examples, the leaching depth Y may be less than 0.05 mm, less than 0.1 mm, less than 1 mm, less than 2 mm, or less than 3 mm, or greater than 0.4 mm. In some examples, at least 85%, at least 90%, at least 95%, or at least 99% of the catalyst may be removed to the leaching depth from the leached portion of the PDC element. The leaching depth and amount of catalyst removed may be selected based on the intended use of the PCD element 100. Thus, chemical leaching may be used to remove the metal-solvent catalyst and any additions from the body of super hard material 20 either up to a desired depth from an external surface of the body of PCD material or from substantially all of the super hard material 20 whilst maintaining the leaching profile shown in FIG. 3. Following leaching, the body of super hard material 20 may therefore comprise a first volume that is substantially free of a metal-solvent catalyst. However, small amounts of catalyst may remain within interstices that are inaccessible to the leaching process. Additionally, following leaching, the body of super hard material 20 may also comprise a volume that contains a metal-solvent catalyst. In some examples, this further volume may be remote from one or more exposed surfaces of the body of super hard material 20.

The thermally stable region, which may be substantially porous, may extend, for example, a depth of at least about 50 microns or at least about 100 microns from a surface of the PCD structure. Some examples may have a leach depth greater than around 250 microns or up to or greater than around 650 microns and in some examples substantially all of the catalyzing material may be removed from the body of polycrystalline material whilst maintaining the leaching profile of FIG. 3.

It is to be understood that the exact depth of the thermally stable region can be selected to and will vary depending on the desired particular end use drilling and or cutting applications.

Once leached to the desired depth, the PCD construction 470 and support fixture 420 are removed from the leaching vessel. This may occur prior to or after removal of the leaching agent from the leaching vessel. After removal, the PCD construction 470 may optionally be washed, cleaned, or otherwise treated to remove or neutralize residual leaching agent. Finally, the PCD construction 470 is removed from the support fixture 420.

All of these steps may also be performed by hand or using an automated system, such as a robotic system.

As mentioned above, the present applicant has appreciated that it may be advantageous to leach the body of PCD material prior to finial finishing of the body to include, for example, the chamfer 44. Therefore, after removal of the leached PCD construction 470 from the support fixture 420, the PCD construction may be subjected to further finishing treatments such as lapping or grinding to create, for example a chamfer extending between the working surface 34 and barrel 42. The length and angel of the chamfer will depend on the intended application of the PCD construction but may be, for example, a 45° chamfer of approximately 0.4 mm height.

Suitable acid leaching mixtures may include but are not limited to HF-HNO3 which may be an effective media for the removal of tungsten carbide (WC) from a sintered PCD table. Alternatively, HCl and other similar mineral acids are easier to work with at high temperatures than HF-HNO3 and are aggressive towards the catalyst/solvent, particularly cobalt (Co). HCl, for example, may remove the bulk of the catalyst/solvent from the PCD table in a reasonable time period, depending on the temperature, typically in the region of 80 hours.

According to some examples, the leaching solution may comprise one or more mineral acids and a complexing agent. In some examples, the leaching solution may comprise one or more mineral acids and diluted nitric acid.

Examples of suitable mineral acids may include, for example, hydrochloric acid, phosphoric acid, sulphuric acid, hydrofluoric acid, and/or any combination of the foregoing mineral acids.

The polycrystalline super hard layer 20 to be leached by examples of the method may, but not exclusively, have a thickness of about 1.5 mm to about 3.5 mm.

Control of where the PCD element is leached may be important for a number of reasons. Firstly, it may be desirable not to remove the catalyst from all areas of the PCD, such as regions that are not exposed to such extreme heat or that may benefit from the mechanical strength conferred by the catalyst. Secondly, the substrate is typically made of a material such as tungsten carbide whose resistance to harsh leaching conditions is far less than that of the diamond matrix. Accordingly, exposure of the substrate to the leaching mixture may cause serious damage to the substrate, often rendering the PCD element as a whole useless. Thirdly, the presence of the catalyst in the PCD near the substrate may be useful to assist in strengthening the region of the interface between the substrate and the PCD so that the PCD body does not separate from the substrate during use of the element. It may therefore be important to protect the interface region from the leaching mixture.

After leaching, leached depths of the PCD table may be determined for various portions of the PCD table, through conventional x-ray analysis. Furthermore, the profile of boundary 50 between the leached and unleached regions in the PCD construction 10 may be determined by a number of techniques including non-destructive x-ray analysis wherein the cutter is x-rayed after leaching, SEM imaging techniques wherein a polished section of the construction is obtained by means of a wire EDM. The cross section may be polished in preparation for viewing by a microscope, such as a scanning electron microscope (SEM) and a series of micrographic images may be taken. Each of the images may be analyzed by means of image analysis software to determine the profile of the cross-section.

The construction may be processed by grinding and polishing as a post-synthesis treatment to provide an insert for a rock-boring drill bit.

Examples are described in more detail below which are provided herein by way of illustration only and are not intended to be limiting.

### EXAMPLE 1

A quantity of sub-micron cobalt powder sufficient to obtain 2 mass % in the final diamond mixture was initially de-agglomerated in a methanol slurry in a ball mill with WC milling media for 1 hour. A fine fraction of diamond powder with an average grain size of 2 microns was then added to the slurry in an amount to obtain 10 mass % in the final mixture. Additional milling media was introduced and further methanol was added to obtain suitable slurry; and this was milled for a further hour. A coarse fraction of diamond, with an average grain size of approximately 20 microns was then added in an amount to obtain 88 mass % in the final mixture. The slurry was again supplemented with further methanol and milling media, and then milled for a further 2 hours. The slurry was removed from the ball mill and dried to obtain the diamond powder mixture.

The diamond powder mixture was then placed into a suitable HpHT vessel, adjacent to a tungsten carbide substrate and sintered at a pressure of around 6.8 GPa and a temperature of about 1500 deg. C.

### EXAMPLE 2

A quantity of sub-micron cobalt powder sufficient to obtain 2.4 mass % in the final diamond mixture was initially de-agglomerated in a methanol slurry in a ball mill with WC milling media for 1 hour. A fine fraction of diamond powder with an average grain size of 2 microns was then added to the slurry in an amount to obtain 29.3 mass % in the final mixture. Additional milling media was introduced and further methanol was added to obtain a suitable slurry; and this was milled for a further hour. A coarse fraction of diamond, with an average grain size of approximately 20 microns was then added in an amount to obtain 68.3 mass % in the final mixture. The slurry was again supplemented with further methanol and milling media, and then milled for a further 2 hours. The slurry was removed from the ball mill and dried to obtain the diamond powder mixture.

The diamond powder mixture was then placed into a suitable HpHT vessel, adjacent to a tungsten carbide substrate and sintered at a pressure of around 6.8 GPa and a temperature of about 1500 deg. C.

The PCD constructions of examples 1 and 2 were then individually placed in a fixture as shown in FIG. 4 and subjected to a leaching treatment process as described above to achieve the leaching profile of that shown in FIG. 3.

In order to test the wear resistance of the sintered polycrystalline products formed according to the above methods, further control cutters were formed having the same composition as the PCD constructions of examples 1 and 2 but having a leaching profile with a substantially uniform leach depth extending across the diameter of the construction but tapering downwardly at the intersection with the barrel of the PCD body rather than the upwardly tapered leaching profile of FIG. 3. The diamond layers were then polished and a subjected to a vertical boring mill test. In this test, the wear flat area was measured as a function of the number of passes of the cutter element boring into the workpiece. The results obtained are illustrated graphically in FIG. 5. The results provide an indication of the total wear scar area plotted against cutting length.

It will be seen that the PCD compacts formed according to an example having the leaching profile of FIG. 3 (CG-B cutter 5 and CG-B cutter 11 in FIG. 5) were able to achieve a significantly greater cutting length and smaller wear scar area than the control cutter denoted by CG-A cutter 3 in FIG. 5.

The present applicant has surprisingly determined that, contrary to conventional expectations, if the depth Y tapers towards the working surface 34 at the intersection with the barrel 42 such that the leach depth at the longitudinal axis of the cutter is greater than the leach depth at the barrel surface 42, this may assist in controlling spalling events during use of the PCD construction as cracks have a tendency to propagate in the PCD along the interface between leached and unleached regions of the PCD and therefore control of the profile of the boundary 50 may assist in managing the thermal wear events of the construction 10 in use and assist in managing the spalling by diverting cracks initiating at the leached/unleached boundary into the centre of the cutter thereby potentially delaying the onset of spalling and prolonging the working life of the construction.

Furthermore, it has been appreciated by the applicant that the creation of the desired profile of this interface boundary 50 including the location and contour in the PCD table of the interface boundary 50 between leached 51 and unleached regions 52 may be controlled through inhibiting the leaching mixture from penetrating the barrel 42 of the cutter from the outer peripheral surface thereof and the cutting edge and controlling instead the exposure of the PCD body 20 to the acid leaching mixture through other exposed surfaces of the PCD body. The desired profile of this interface boundary 50 including the location and contour thereof may enable the provision of a PCD material having increased resistance to spalling and chipping. It has further been appreciated by the present applicant that additional control of the location and contour of the interface boundary 50 may be achieved if the treatment of the PCD body to remove non-super hard phase material from the interstices in the PCD body is carried out on the PCD body prior to final finishing of the body such as to create the chamfer shown in FIG. 3.

Whilst not wishing to be bound by a particular theory, using the conditions described herein it was determined possible to achieve a mechanically stronger and more wear-resistant body of PCD material which, when used as a cutter, may significantly enhance the durability of the cutter produced according to some examples described herein.

The preceding description has been provided to enable others skilled the art to best utilize various aspects of the examples. This description is not intended to be exhaustive or to be limited to any precise form disclosed. Many modifications and variations are possible. In particular, the method described is equally applicable to the effective leaching of PCD with other acid combinations such as mineral acids and/or complexing agents. Furthermore, whilst the use of the support fixture shown in FIG. 4 has been described as being particularly effective for use with the described method, it will be appreciated that the shape of the fixture illustrated and described should not be taken to be limiting as other shapes of fixture will be appreciated.

1. A method of making a thermally stable polycrystalline super hard construction comprising a plurality of interbonded super hard grains and interstitial regions disposed therebetween to form a polycrystalline super hard construction having a first thermally stable region and a second region, the first thermally stable region forming at least part of a working surface of the construction, the method comprising:
treating the polycrystalline super hard material with a leaching mixture to remove non-super hard phase material from a number of interstitial regions in the first region;
the step of treating comprising masking the polycrystalline super hard construction along at least a portion of the peripheral side surface up to and/or at the working surface to inhibit penetration of the leaching mixture into the super hard construction through a peripheral side surface of the super hard construction.

2. The method of claim 1, wherein the step of removing non-super hard phase material from the interstitial regions in the first region comprises removing the non-super hard phase material to a depth in the first region that tapers towards the working surface at the intersection of the first region with the peripheral side surface of the polycrystalline super hard construction such that the depth of the first region at the peripheral side surface is less than the depth of the majority of the first region.

3. The method of claim 1, further comprising machining the polycrystalline super hard construction to form a chamfer extending between a working surface positioned along an outside portion of the body and a peripheral side surface of the body after the step of treating the super hard construction with the leaching mixture.

4. The method of claim 1, wherein the polycrystalline super hard construction is formed of polycrystalline diamond material.

5. The method of claim 4, wherein the step of treating to remove non-super hard phase material comprises removing solvent/catalyst from the interstitial regions in the first region.

6. The method of claim 1, wherein the step of treating further comprises masking the super hard body across a portion of the working surface adjacent the intersection of the working surface with the peripheral side surface in addition to masking the super hard body along at least a portion of the peripheral side surface up to the working surface to inhibit penetration of the leaching mixture into the super hard construction through a peripheral side surface of the super hard construction and a portion of the working surface.

7. The method of claim 1, wherein the step of masking the polycrystalline super hard construction comprises any one or more of coating the super hard construction with a protective layer or mask, or placing a sealing member on and/or around the polycrystalline super hard construction.

8. The method of claim 1, wherein the polycrystalline super hard construction comprises a cutting edge at the intersection of the working surface with the peripheral side surface of the construction, the step of removing non-super hard phase material from the interstitial regions in the first region comprising removing the material to a depth in the first region such the first region intersects the peripheral side surface at a position at least around 100 microns from the cutting edge.

9. The method of claim 1, wherein the polycrystalline super hard construction comprises a cutting edge at the intersection of the working surface with the peripheral side surface of the construction, the step of removing non-super hard phase material from the interstitial regions in the first region comprising removing the material to a depth in the first region such the first region intersects the peripheral side surface at a position between around 50 to 100 microns from the cutting edge.

10. The method of claim 1, wherein the polycrystalline super hard construction comprises a cutting edge at the intersection of the working surface with the peripheral side surface of the construction, the step of removing non-super hard phase material from the interstitial regions in the first region comprising removing the material to a depth in the first region such the first region intersects the peripheral side surface at a position less than around 50 microns from the cutting edge.

11. The method of claim 1, wherein the step of removing non-super hard phase material from the interstitial regions in the first region comprises removing the material such that a majority of the super hard grains in the body within a depth of between around 250 microns to around 650 microns from the working surface have a surface which is substantially free of contact with non-super hard phase material, the remaining grains contacting non-super hard phase material.

12. The method of claim 1, wherein prior to the step of treating, forming the polycrystalline super hard construction, the step of forming comprising:
providing a mass of diamond grains;
arranging the mass of diamond grains to form a pre-sinter assembly; and
treating the pre-sinter assembly in the presence of catalyst/solvent material for the diamond grains at an ultra-high pressure of around 5.5 GPa or greater and a temperature at which the diamond material is more thermodynamically stable than graphite to sinter together the grains of diamond material to form a polycrystalline diamond construction.

13. The method of claim 1, wherein prior to the step of treating, the method further comprising machining the polycrystalline super hard body to a final dimension.

14. The method of claim 1, wherein after the step of treating, the method further comprising machining the polycrystalline super hard body to a final dimension.

15. (canceled)
